(19) United States
(12) Patent Application Publication
(10) Pub. No.: US 2006/0246291 A1
(43) Pub. Date: Nov. 2, 2006

(54) Method for forming functional layers

(76) Inventors: Martin Kunz, Efringen-Kirchen (DE); Michael Bauer, Forchheim (DE); Andreas Baranyai, Heitersheim (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/538,893

(22) PCT Filed: Dec. 15, 2003
(86) PCT No.: PCT/EP03/51008

§ 371 Date: Nov. 15, 2005

(30) Foreign Application Priority Data
Dec. 20, 2002 (DE) 10260332.4

(51) Int. Cl. B32B 9/00; H05H 1/24; B05D 3/00; B29C 71/02

(52) U.S. Cl. 428/411.1; 427/569; 427/532

(57) ABSTRACT

The invention relates to a method for forming functional layers on an inorganic or organic substrate, wherein a) a low-temperature plasma, a corona discharge, high-energy radiation and/or a flame treatment is caused to act on the inorganic or organic substrate, b) 1) at least one activatable initiator or 2) at least one activatable initiator and at least one ethylenically unsaturated compound is/are applied in the form of a melt, solution, suspension or emulsion to the inorganic or organic substrate, there being incorporated in the activatable initiator and/or the ethylenically unsaturated compound at least one function-controlling group which results in the treated substrate's acquiring desired surface properties, and c) the coated substrate is heated and/or is irradiated with electromagnetic waves, the substrate thereby acquiring the desired surface properties. The invention relates also to substrates coated in accordance with the method and to their use.

The invention relates to a method for forming functional layers on an inorganic or organic substrate, and to a substrate treated in accordance with the method and to its use. Plasma processes have been used for the production of functional layers on surfaces for some time. Plasma polymerisation, in particular, is frequently used in this respect. For that purpose, polymerisable precursors are supplied to a low pressure plasma by way of the gas phase and are deposited on the surface in polymerised form. Techniques used for that purpose and the surfaces thereby obtained as well as their use are described, for example, in “Plasma Surface Modification and Plasma Polymerization” by N. Inagaki, Technomic Publishing Company Inc., Lancaster 1996, “Plasma Polymerization” by H. Yasuda, Academic Press Inc., New York 1985 and “Plasma Polymerization Processes” by H. Biederman, Y. Osada, Elsevier Science Publishers, Amsterdam 1992.

The plasma-assisted deposition of polymerisable compounds frequently results in unforeseeable modifications of the structures at the molecular level. Especially when functional groups are present in the molecule, degradation reactions and other changes may occur. In plasma, functional groups can readily be oxidised or split off. In addition, the molecules used can be totally destroyed by the short-wave radiation and high-energy species, such as ions and free radicals, present in the plasma. The deposited or polymerised film may therefore have much poorer properties or properties completely different from those of the compounds originally used. In order to retain the structure to the maximum degree, use is therefore increasingly being made of pulsed plasmas, in which a short plasma pulse for initiating the polymerisation is followed by a longer phase in which the plasma is switched off but the supply of polymerisable compounds is maintained. This results in a process having lower efficiency and even greater complexity, however. Such processes are described, for example, by G. Kühn et al. in Surfaces and Coatings Technology 142, 2001, page 494.

Furthermore, the mentioned plasma techniques need to be carried out in vacuo and accordingly require complex apparatus and time-consuming procedures. Moreover, the compounds (precursors) to be applied or polymerised have to be vaporised and recondensed on the substrate, which can lead to high levels of thermal stress and, in many cases, to decomposition. In addition, the vaporisation and deposition rates are low, with the result that the production of layers of adequate thickness is difficult and laborious.

DE 197 32 901 C1, G. Bolte, S. Kluth in Coating February 1998 page 38 and G. Bolte, R. Könemann in Coating October 2001 page 364 describe the use of a corona treatment of surfaces at atmospheric pressure, the precursors being introduced into the discharge chamber in the form of vapours, aerosols or dusts and being deposited on the surfaces to be treated. In this case too, the precursors are exposed to high energies, UV light and reactive gases (e.g. ozone), which may lead to the destruction of the polymerisable compounds. Furthermore, the rate of application is low on account of the rate at which the aerosols are generated, and deposits may be formed on the electrodes, which necessitates frequent cleaning and consequent stopping of the machinery. In addition, only water can be used as liquid phase, which severely limits the choice of compounds and precursors that can be used.

Surprisingly, a method has how been found which makes it possible to produce functional layers without the afore-mentioned disadvantages. The invention relates to a method for forming functional layers on an inorganic or organic substrate, wherein

a) a low-temperature plasma, a corona discharge, high-energy radiation and/or a flame treatment is caused to act on the inorganic or organic substrate,

b) 1) at least one activatable initiator or 2) at least one activatable initiator and at least one ethylenically unsaturated compound is/are applied in the form of a melt, solution, suspension or emulsion to the inorganic or organic substrate, there being incorporated in the activatable initiator and/or the ethylenically unsaturated compound at least one function-controlling group which results in the treated substrate's acquiring desired surface properties, and

c) the coated substrate is heated and/or is irradiated with electromagnetic waves, the substrate thereby acquiring the desired surface properties.

The activatable initiator used is preferably a free-radical-forming initiator.

The following advantages of such a method may be mentioned: by means of the described method, clear transparent layers are formed on a great variety of substrates, which layers also exhibit good adhesion. In combination with ethylenically mono- or poly-unsaturated compounds (monomers, oligomers or polymers), the properties of the layers produced may be varied within wide limits. Controlling the thickness is likewise made simpler and is possible within very wide limits. An advantage of this method is that it can be carried out at normal pressure and does not require complex vacuum apparatus. Excessive thermal stress on the substrates and on the substances used is avoided, so that it is possible to effect targeted introduction of chemical functionalities to obtain the desired properties. Because conventional application methods can be used, the deposition rates are very high and are virtually unrestricted. Because the substances do not need to be vaporised, it is also possible to use compounds of low volatility or high molecular weight. A large range of compounds is therefore available, and the specific properties required can readily be obtained.

In a preferred embodiment, the function-controlling group is composed as follows:
i) a hydrophilic or hydrophobic group for controlling hydrophilicity/hydrophobicity,
ii) an acid, neutral or basic functional group for controlling acid/base properties,
iii) a functional group having high or low incremental refraction, for controlling the refractive index,
iv) a functional group having an effect on the growth of cells and/or organisms, for controlling biological properties,
v) a functional group having an effect on combustibility, for controlling flame-retardant properties, and/or
vi) a functional group having an effect on electrical conductivity, for controlling anti-static properties.

As hydrophilic group there is preferably used a polar group, such as an alcohol, ether, acid, ester, aldehyde, keto, sugar, phenol, urethane, acrylate, vinyl ether, epoxy, amide, acetal, ketal, anhydride, quaternised amino, imide, carbonate or nitro group, a salt of an acid, or a (poly)glycol unit. Especially good results are obtained using acrylic acid, acrylamide, acetoxystyrene, acrylic anhydride, acrylsuccinimide, allyl glycidyl ether, allylmethoxyphenol, polyethylene glycol (400) diacrylate, diethylene glycol diacrylate, diurethane dimethacrylate, divinyl glycol, ethylene glycol diglycidyl ether, glycidiyl acrylate, glycol methacrylate, 4-hydroxybutyl methacrylate, 2-hydroxyethyl acrylate, 2-hydroxyethyl methacrylate, N-(2-hydroxypropyl)methacrylamide, methacryloxyethyl glucoside, nitrostyrene, sulfoethyl methacrylate, sodium salt of 3-sulfopropyl acrylate, 4-vinylbenzoic acid, vinyl methyl sulfone, vinylphenylacetate or vinylurea as the hydrophilic group. The following substances are also suitable:

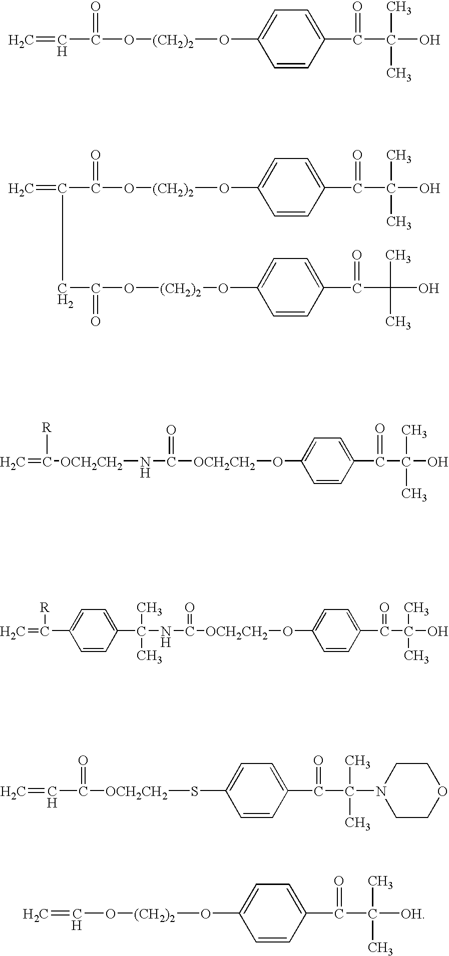

As hydrophobic group there is preferably used a non-polar group, such as a branched or unbranched alkane, alkene, alkyne, partially or fully halogenated alkane or alkene or alkyne, alkylated amine, linear or branched silane or siloxane group or a partially or fully halogenated aromatic or non-aromatic cyclic group. Special preference is given to tert-butyl acrylate, styrene, butyltrimethoxysilane, cyclohexyl acrylate, decanediol dimethacrylate, divinylbenzene, 2-(2-ethoxyethoxy)ethyl acrylate, 1H,1H-heptafluorobutyl acrylate, benzyl acrylate, 1H,1H,7H-dodecafluoroheptyl methacrylate, naphthyl acrylate, pentabromophenyl acrylate, trifluoroethyl acrylate or vinyltriphenylsilane. The following substances are also suitable:

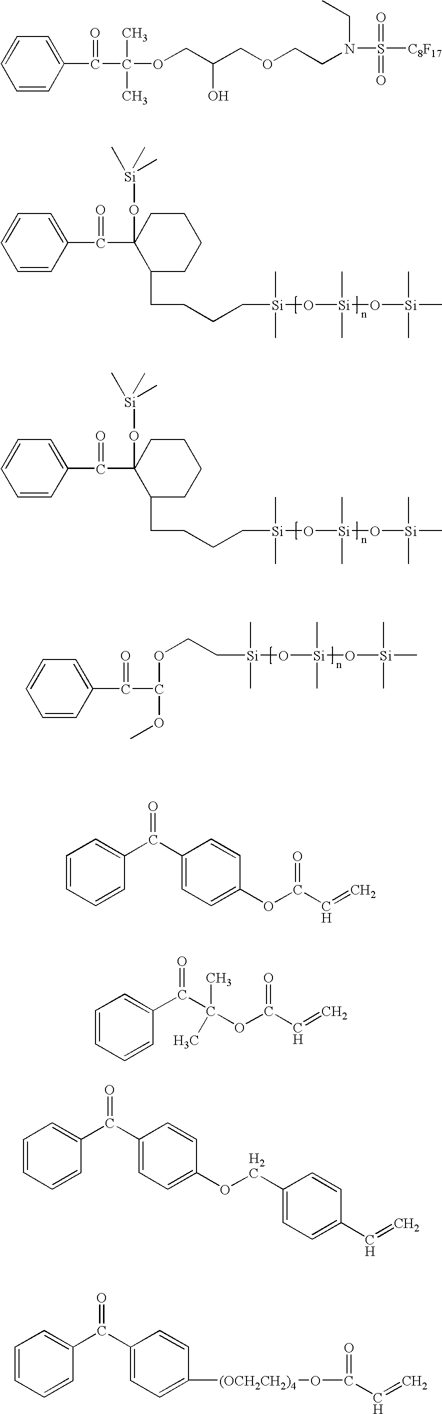

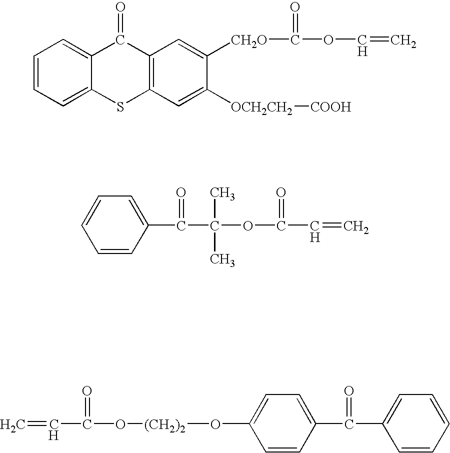

4-vinyloxycarbonyloxy-4′-chlorobenzophenone,

vinyloxycarbonyloxy-4′-fluorobenzophenone,

2-vinyloxycarbonyloxy-5-fluoro-4′-chlorobenzophenone.

As a functional group controlling acid/base properties there is preferably used a carboxylic acid, sulfonic acid, phosphoric acid, sulfuric acid, phenolic acid or amino acid group or an amino, pyridine, pyrimidine, piperidine, pyrrole or imidazole group. The use of allylamine, 2-aminoethyl methacrylate, 4-vinylpyridine, vinylpyrrolidone, vinylimidazole, morpholinoethyl acrylate, acrylic acid, 2-propene-1-sulfonic acid, sorbic acid, cinnamic acid or maleic acid is especially advantageous.

For controlling the refractive index there is preferably used a benzyl group, a partially or fully halogenated benzyl group or a partially or fully halogenated alkane, alkene or alkyne group, the use of benzyl acrylate, 1H,1H,7H-dodecafluoroheptyl methacrylate, 1H,1H-heptafluorobutyl acrylate and trifluoroethyl acrylate having proved especially advantageous.

As a group controlling the biological properties it is possible to use a group having anti-fouling properties, such as copper(II) methacrylate, dibutyltin maleate, tin(II) methacrylate or zinc dimethacrylate.

A further possible way of controlling the biological properties lies in the use of a group that promotes the growth of biological systems. It has proved especially advantageous to use succinimide, glucoside and sugar groups for this purpose, N-acyloxysuccinimide and 2-methacryloxyethyl glucoside achieving particularly good results.

As a group controlling the flame-retardant properties there is used a fully or partially chlorinated or brominated alkane or nitrogen- or phosphorus-containing group. Such a group is especially phenyl tribromomethylsulfone, 2,2,2-trichloro-1-[4-(1,1-dimethylethyl)phenyl]-ethanone, tribromoneopentyl methacrylate, bis(2-methacryloxyethyl)phosphate or monoacryloxyethyl phosphate.

The anti-static properties can also be controlled by the selection of a suitable functional group. Functional groups especially suitable for this purpose are tertiary amino, ethoxylated amino, alkanol amide, glycerol stearate, sorbitan and sulfonate groups, such as, especially, 2-diisopropylaminoethyl methacrylate, 3-dimethylaminoneopentyl acrylate or oleylbis(2-hydroxyethyl)amine, stearyl acrylate and/or vinyl stearate. The following substances are also suitable:

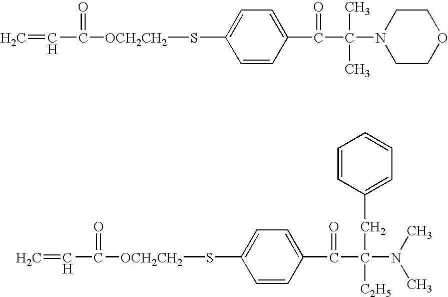

The substrates may be in the form of a powder, a fibre, a woven fabric, a felt, a film or a three-dimensional workpiece. Preferred substrates are synthetic or natural polymers, metal oxides, glass, semi-conductors, quartz or metals, or materials containing such substances. As a semi-conductor substrate, special mention should be made of silicon, which may be, for example, in the form of “wafers”. Metals include especially aluminium, chromium, steel, vanadium, which are used for the production of high-quality mirrors, for example telescope mirrors or vehicle headlamp mirrors. Aluminium is especially preferred.

Examples of natural and synthetic polymers or plastics are listed below.

i) Polymers of mono- and di-olefins, for example polypropylene, polyisobutylene, polybutene-1, poly-4-methylpentene-1, polyisoprene or polybutadiene and also polymerisates of cyclo-olefins, for example of cyclopentene or norbornene; and also polyethylene (which may or may not be crosslinked), for example high density polyethylene (HDPE), high density polyethylene of high molecular weight (HDPE-HMW), high density polyethylene of ultra-high molecular weight (HDPE-UHMW), medium density polyethylene (MDPE), low density polyethylene (LDPE), and linear low density polyethylene (LLDPE), (VLDPE) and (ULDPE);

ii) mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE);

iii) copolymers of mono- and di-olefins with one another or with other vinyl monomers, for example ethylene/propylene copolymers, linear low density polyethylene (LLDPE) and mixtures thereof with low density polyethylene (LDPE), and also mixtures of such copolymers with one another or with polymers mentioned under i), for example polypropylene-ethylene/propylene copolymers, LDPE-ethylene /vinyl acetate copolymers, LDPE-ethylene/acrylic acid copolymers, LLDPE-ethylene/vinyl acetate copolymers, LLDPE-ethylene/acrylic acid copolymers and alternately or randomly structured polyalkylene-carbon monoxide copolymers and mixtures thereof with other polymers, for example polyamides;

iv) hydrocarbon resins (for example C₅-C₉) including hydrogenated modifications thereof (for example tackifier resins) and mixtures of polyalkylenes and starch;

v) polystyrene, poly(p-methylstyrene), poly(α-methylstyrene);

vi) copolymers of styrene or α-methylstyrene with dienes or acrylic derivatives, for example styrene/butadiene, styrene/acrylonitrile, styrene/alkyl methacrylate, styrene/butadiene/alkyl acrylate and methacrylate, styrene/maleic anhydride, styrene/acrylonitrile/methyl acrylate;

vii) graft copolymers of styrene or α-methylstyrene, for example styrene on polybutadiene, styrene on polybutadiene/styrene or polybutadiene/acrylonitrile copolymers, styrene and acrylonitrile (or methacrylonitrile) on polybutadiene; and mixtures thereof with the copolymers mentioned under vi), such as those known, for example, as so-called ABS, MBS, ASA or AES polymers;

viii) halogen-containing polymers, for example polychloroprene, chlorinated rubber, chlorinated and brominated copolymer of isobutylene/isoprene(halobutyl rubber), chlorinated or chlorosulfonated polyethylene, copolymers of ethylene and chlorinated ethylene, epichlorohydrin homo- and co-polymers, especially polymers of halogen-containing vinyl compounds, for example polyvinyl chloride, polyvinylidene chloride, polyvinyl fluoride, polyvinylidene fluoride; and copolymers thereof, such as vinyl chloride/vinylidene chloride, vinyl chloride/vinyl acetate or vinylidene chloride/vinyl acetate;

ix) polymers derived from α,β-unsaturated acids and derivatives thereof, such as polyacrylates and polymethacrylates, or polymethyl methacrylates, polyacrylamides and polyacrylonitriles impact-resistant-modified with butyl acrylate;

x) copolymers of the monomers mentioned under ix) with one another or with other unsaturated monomers, for example acrylonitrile/butadiene copolymers, acrylonitrile/alkyl acrylate copolymers, acrylonitrile/alkoxyalkyl acrylate copolymers, acrylonitrile/vinyl halide copolymers or acrylonitrile/alkyl methacrylate/butadiene terpolymers;

xi) polymers derived from unsaturated alcohols and amines or their acyl derivatives or acetals, such as polyvinyl alcohol, polyvinyl acetate, stearate, benzoate or maleate, polyvinylbutyral, polyallyl phthalate, polyallylmelamine; and the copolymers thereof with olefins mentioned in Point 1;

xii) homo- and co-polymers of cyclic ethers, such as polyalkylene glycols, polyethylene oxide, polypropylene oxide or copolymers thereof with bisglycidyl ethers;

xiii) polyacetals, such as polyoxymethylene, and also those polyoxymethylenes which contain comonomers, for example ethylene oxide; polyacetals modified with thermoplastic polyurethanes, acrylates or with MBS;

xiv) polyphenylene oxides and sulfides and mixtures thereof with styrene polymers or polyamides;

xv) polyurethanes derived from polyethers, polyesters and polybutadienes having terminal hydroxyl groups on the one hand and aliphatic or aromatic polyisocyanates on the other hand, and their initial products;

xvi) polyamides and copolyamides derived from diamines and dicarboxylic acids and/or from aminocarboxylic acids or the corresponding lactams, such as polyamide 4, polyamide 6, polyamide 6/6, 6/10, 6/9, 6/12, 4/6, 12/12, polyamide 11, polyamide 12, aromatic polyamides derived from m-xylene, diamine and adipic acid; block copolymers of the above-mentioned polyamides with polyolefins, olefin copolymers, ionomers or chemically bonded or grafted elastomers; or with polyethers, for example with polyethylene glycol, polypropylene glycol or polytetramethylene glycol. Also polyamides or copolyamides modified with EPDM or with ABS; and polyamides condensed during processing (“RIM polyamide systems”);

xvii) polyureas, polyimides, polyamide imides, polyether imides, polyester imides, polyhydantoins and polybenzimidazoles;

xviii) polyesters derived from dicarboxylic acids and dialcohols and/or from hydroxycarboxylic acids or the corresponding lactones, such as polyethylene terephthalate, polybutylene terephthalate, poly-1,4-dimethylolcyclohexane terephthalate, polyhydroxybenzoates, and also block polyether esters derived from polyethers with hydroxyl terminal groups; and also polyesters modified with polycarbonates or with MBS;

xix) polycarbonates and polyester carbonates;

xx) polysulfones, polyether sulfones and polyether ketones;

xxi) crosslinked polymers derived from aldehydes on the one hand and phenols, urea or melamine on the other hand, such as phenol-formaldehyde, urea-formaldehyde and melamine-formaldehyde resins;

xxii) drying and non-drying alkyd resins;

xxiii) unsaturated polyester resins derived from copolyesters of saturated and unsaturated dicarboxylic acids with polyhydric alcohols, and from vinyl compounds as crosslinking agents, and also the halogen-containing, difficultly combustible modifications thereof;

xxiv) crosslinkable acrylic resins derived from substituted acrylic acid esters, e.g. from epoxy acrylates, urethane acrylates or polyester acrylates;

xxv) alkyd resins, polyester resins and acrylate resins that are crosslinked with melamine resins, urea resins, isocyanates, isocyanurates, polyisocyanates or epoxy resins;

xxvi) crosslinked epoxy resins derived from aliphatic, cycloaliphatic, heterocyclic or aromatic glycidyl compounds, e.g. products of diglycidyl ethers of bisphenol A, diglycidyl ethers of bisphenol F, which are crosslinked using customary hardeners, e.g. anhydrides or amines with or without accelerators;

xxvii) silicon-containing polymers, such as polysiloxanes and polysilanes, and crosslinked and/or copolymerised derivatives thereof;

xxviii) natural polymers, such as cellulose, natural rubber, gelatin, or polymer-homologue-chemically modified derivatives thereof, such as cellulose acetates, propionates and butyrates, and the cellulose ethers, such as methyl cellulose; and also colophonium resins and derivatives;

xxix) mixtures (polyblends) of the afore-mentioned polymers, for example PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

In the case of natural polymers, there may be mentioned as being especially preferred carbon fibres, cellulose, starch, cotton, rubber, colophonium, wood, flax, sisal, polypeptides, polyamino acids and derivatives thereof.

The synthetic polymer is preferably a polycarbonate, polyester, halogen-containing polymer, polyacrylate, polyolefin, polyamide, polyurethane, polystyrene and/or polyether.

The synthetic materials can be in the form of films, injection-moulded articles, extruded workpieces, fibres, felts or woven fabrics. In addition to components for the automotive industry, articles such as spectacles or contact lenses may also be provided with a functional layer.

Possible ways of obtaining plasmas under vacuum conditions have been described frequently in the literature. The electrical energy can be coupled in by inductive or capacitive means.

It may be direct current or alternating current; the frequency of the alternating current may vary from a few kHz up into the MHz range. A power supply in the microwave range (GHz) is also possible. The principles of plasma generation and maintenance are described, for example, by A. T. Bell, “Fundamentals of Plasma Chemistry” in “Technology and Application of Plasma Chemistry”, edited by J. R. Holahan and A. T. Bell, Wiley, New York (1974) or by H. Suhr, Plasma Chem. Plasma Process 3(1),1, (1983).

As primary plasma gases there may be used, for example, He, argon, xenon, N₂, O₂, H₂, steam or air. The method according to the invention is not per se sensitive with respect to the coupling-in of electrical energy. The method can be carried out in batch operation, for example in a rotating drum, or, in the case of films, fibres or woven fabrics, in continuous operation. Such procedures are known and are described in the prior art.

The method can also be carried out under corona discharge conditions. Corona discharges are generated under normal pressure conditions, the ionised gas most frequently used being air. In principle, however, other gases and mixtures are also possible, as described, for example, in COATING Vol. 2001, No. 12, 426, (2001). The advantage of air as ionising gas in corona discharges is that the procedure can be carried out in apparatus that is open to the outside and that, for example, a film can be drawn through continuously between the discharge electrodes. Such process arrangements are known and are described, for example, in J. Adhesion Sci. Technol. Vol 7, No. 10, 1105, (1993). Three-dimensional workpieces can be treated using a free plasma jet, the contours being followed with the assistance of robots.

The method can be performed within a wide pressure range, the discharge characteristics being shifted, as pressure increases, from a pure low-temperature plasma towards corona discharge and finally, at atmospheric pressure of approximately 1000-1100 mbar, changing into a pure corona discharge.

The method is preferably carried out at a process pressure of from 10⁻⁶ mbar up to atmospheric pressure (1013 mbar), especially at atmospheric pressure in the form of a corona process.

The method is preferably carried out by using, as plasma gas, an inert gas or a mixture of an inert gas with a reactive gas.

Where a corona discharge is used, the gas employed is preferably air, CO₂ and/or nitrogen.

The use of H₂, CO₂, He, Ar, Kr, Xe, N₂, O₂ and H₂O as plasma gases, either singly or in the form of a mixture, is especially preferred.

High-energy radiation, for example in the form of light, UV light, electron beams and ion beams, can likewise be used for activating the surface.

As activatable initiators there come into consideration all compounds or mixtures of compounds that generate one or more free radicals (also in the form of intermediates) when heated and/or irradiated with electromagnetic waves. Such initiators, in addition to including compounds or combinations that are usually thermally activated, such as, for example, peroxides and hydroperoxides (also in combination with accelerators, such as amines and/or cobalt salts) and amino ethers (NOR compounds), also include photochemically activatable compounds (e.g. benzoins) or combinations of chromophores with coinitiators (e.g. benzophenone and tertiary amines) and mixtures thereof. It is also possible to use sensitisers with coinitiators (e.g. thioxanthones with tertiary amines) or with chromophores (e.g. thioxanthones with aminoketones). Redox systems, such as, for example, combinations of H₂O₂ with iron(II) salts, can likewise be used. It is also possible to use electron-transfer pairs, such as, for example, dyes and borates and/or amines. There may be used as initiator a compound or a combination of compounds from the following classes: peroxides, peroxodicarbonates, persulfates, benzpinacols, dibenzyls, disulfides, azo compounds, redox systems, benzoins, benzil ketals, acetophenones, hydroxyalkylphenones, aminoalkylphenones, acylphosphine oxides, acylphosphine sulfides, acyloxyiminoketones, halogenated acetophenones, phenyl glyoxalates, benzophenones, oximes and oxime esters, thioxanthones, camphorquinones, ferrocenes, titanocenes, sulfonium salts, iodonium salts, diazonium salts, onium salts, alkyl borides, borates, triazines, bisimidazoles, polysilanes and dyes, and also corresponding coinitiators and/or sensitisers.

Preferred compounds are: dibenzoyl peroxide, benzoyl peroxide, dicumyl peroxide, cumyl hydroperoxide, diisopropyl peroxydicarbonate, methyl ethyl ketone peroxide, bis(4-tert-butyl-cyclohexyl)peroxydicarbonate, ammonium peroxomonosulfate, ammonium peroxodisulfate, dipotassium persulfate, disodium persulfate, N,N-azobisisobutyronitrile, 2,2′-azobis(2,4-dimethylpentanenitrile), 2,2′-azobis(2-methylpropanenitrile), 2,2′-azobis(2-methylbutane-nitrile), 1,1′-azobis(cyanocyclohexane), tert-amyl peroxobenzoate, 2,2′-bis(tert-butylperoxy)-butane, 1,1′-bis(tert-butylperoxy)cyclohexane, 2,5-bis(tert-butylperoxy)-2,5-dimethylhexane, 2,5-bis(tert-butylperoxy)-2,5-dimethyl-3-hexyne, 1,1-bis(tert-butylperoxy)-3,3,5-trimethylcyclohexane, tert-butyl hydroperoxide, tert-butyl peracetate, tert-butyl peroxide, tert-butyl peroxybenzoate, tert-butyl peroxyisopropyl carbonate, cyclohexanone peroxide, lauroyl peroxide, 2,4-pentanedione peroxide, 2,5-dimethyl-2,5-di(tert-butylperoxy)hexane, di(2-tert-butylperoxyisopropyl)benzene, cobalt octanoate, dicyclopentadienylchromium, peracetic acid, benzpinacol and dibenzyl derivatives, such as dimethyl-2,3-diphenylbutane, 3,4-dimethyl-3,4-diphenylhexane, poly-1,4-diisopropylbenzene, N,N-dimethylcyclohexyl-ammonium dibutyldithiocarbamate, N-tert-butyl-2-benzothioazole sulfenamide, benzothiazyl disulfide and tetrabenzylthiuram disulfide.

Typical examples of photoactivatable systems, which can be used either singly or in mixtures, are mentioned below. For example benzophenones, benzophenone derivatives, acetophenone, acetophenone derivatives, such as, for example, α-hydroxycycloalkyl phenyl ketones or 2-hydroxy-2-methyl-1-phenyl-propanone, dialkoxyacetophenones, α-hydroxy- or α-amino-acetophenones, such as, for example, (4-methylthiobenzoyl)-1-methyl-1-morpholino-ethane, (4-morpholino-benzoyl)-1-benzyl-1-dimethylaminopropane, 4-aroyl-1,3-dioxol-anes, benzoin alkyl ethers and benzil ketals, such as, for example, benzil dimethyl ketal, phenyl glyoxalates and derivatives thereof, dimeric phenyl glyoxalates, monoacylphosphine oxides, such as, for example, (2,4,6-trimethylbenzoyl)phenylphosphine oxide, bisacylphosphine oxides, such as, for example, bis(2,6-dimethoxybenzoyl)-(2,4,4-trimethyl-pent-1-yl)-phosphine oxide, bis(2,4,6-trimethylbenzoyl)phenylphosphine oxide or bis(2,4,6-trimethylbenzoyl)-(2,4-dipentyloxyphenyl)phosphine oxide, trisacylphosphine oxides, ferrocenium compounds or titanocenes, such as, for example, (η⁵-2,4-cyclopentadien-1-yl)[1,2,3,4,5,6-η)-(1-methylethyl)benzene]iron(+)-hexafluorophosphate(-1) or dicyclopentadienyl-bis(2,6-difluoro-3-pyrrolophenyl)titanium; sulfonium and iodonium salts, such as, for example, bis[4-(diphenylsulfonio)phenyl]sulfide bishexafluorophosphate, (4-isobutylphenyl)-p-tolyl-iodonium hexafluorophosphate.

As coinitiators there come into consideration, for example, sensitisers that shift or broaden the spectral sensitivity and thus bring about an acceleration of the photopolymerisation. Such sensitisers are especially aromatic carbonyl compounds, for example benzophenone derivatives, thioxanthone derivatives, especially also isopropylthioxanthone, anthraquinone derivatives and 3-acylcoumarin derivatives, triazines, coumarins, terphenyls, styryl ketones, and also 3-(aroylmethylene)-thiazolines, camphorquinone, and also eosin, rhodamine and erythrosine dyes. As coinitiators it is also possible to use tert-amines, thiols, borates, phenylglycines, phosphines and other electron donors.

Preference is given to the use of initiators that contain ethylenically unsaturated groups, because in that way they are incorporated into the polymer chain and thus into the layer during the polymerisation process. Ethylenically unsaturated groups that come into consideration, in addition to vinyl and vinylidene groups, are especially acrylate, methacrylate, allyl and vinyl ether groups.

The ethylenically unsaturated compounds may contain one or more olefinic double bonds. They may be low molecular weight (monomeric) or higher molecular weight (oligomeric, polymeric). By skilful selection of such compounds it is possible to control the properties of the functional layers within wide limits. For example, hydrophilic layers can be produced by the use of water-soluble compounds; water-repellent layers can be produced by the use of hydrophobic compounds (for example fluorinated compounds or acrylated waxes).

Examples of monomers having a double bond are alkyl or hydroxyalkyl acrylates or methacrylates, for example methyl, ethyl, butyl, 2-ethylhexyl or 2-hydroxyethyl acrylate, isobornyl acrylate and methyl or ethyl methacrylate. Also of interest are silicone (meth)acrylates and fluorinated acrylates and methacrylates. Salts or hydrochloride adducts (e.g. the sodium salt of 3-sulfopropyl acrylate, 2-aminoethyl methacrylate hydrochloride) of unsaturated compounds can also be used. Further examples are acrylonitrile, acrylamide, methacrylamide, N-substituted (meth)acrylamides, vinyl esters, such as vinyl acetate, vinyl ethers, such as isobutyl vinyl ether, styrene, alkyl styrenes and halostyrenes, maleic acid or maleic anhydride, N-vinylpyrrolidone, vinyl chloride or vinylidene chloride. There may also be used unsaturated compounds that carry additional groups having an acidic, neutral or basic reaction (e.g. allylamine, 2-aminoethyl methacrylate, 4-vinylpyridine, acrylic acid, 2-propene-1-sulfonic acid). Organometal compounds having unsaturated groups can also be used.

Examples of monomers having more than one double bond are ethylene glycol diacrylate, propylene glycol diacrylate, neopentyl glycol diacrylate, hexamethylene glycol diacrylate and bisphenol A diacrylate, 4,4′-bis(2-acryloyloxyethoxy)diphenylpropane, trimethylolpropane tri-acrylate, pentaerythritol triacrylate, pentaerythritol tetraacrylate, vinyl acrylate, divinylbenzene, divinyl succinate, diallyl phthalate, triallyl phosphate, triallyl isocyanurate, tris-(hydroxyethyl)isocyanurate triacrylate and tris(2-acryloylethyl)isocyanurate.

Examples of higher molecular weight (oligomeric, polymeric) polyunsaturated compounds are acrylated epoxy resins, acrylated or vinyl-ether- or epoxy-group-containing polyesters, polyurethanes and polyethers. Further examples of unsaturated oligomers are unsaturated polyester resins, which are usually produced from maleic acid, phthalic acid and one or more diols and have molecular weights of about from 500 to 3000. In addition it is also possible to use vinyl ether monomers and oligomers, and also maleate-terminated oligomers having polyester, polyurethane, polyether, polyvinyl ether and epoxide main chains. Especially combinations of vinyl-ether-group-carrying oligomers and polymers, such as are described in WO 90/01512, are very suitable, but copolymers of monomers functionalised with maleic acid and vinyl ether also come into consideration. Such unsaturated oligomers can also be referred to as prepolymers.

There are especially suitable, for example, esters of ethylenically unsaturated carboxylic acids and polyols or polyepoxides, and polymers having ethylenically unsaturated groups in the chain or in side groups, e.g. unsaturated polyesters, polyamides and polyurethanes and copolymers thereof, alkyd resins, polybutadiene and butadiene copolymers, polyisoprene and isoprene copolymers, polymers and copolymers having (meth)acrylic groups in side chains, and also mixtures of one or more such polymers.

Examples of unsaturated carboxylic acids are acrylic acid, methacrylic acid, crotonic acid, itaconic acid, cinnamic acid and unsaturated fatty acids such as linolenic acid and oleic acid. Acrylic and methacrylic acid are preferred.

Suitable polyols are aromatic and especially aliphatic and cycloaliphatic polyols. Examples of aromatic polyols are hydroquinone, 4,4′-dihydroxydiphenyl, 2,2-di(4-hydroxyphenyl)-propane, and novolaks and resols. Examples of polyepoxides are those based on the said polyols, especially the aromatic polyols and epichlorohydrin. Also suitable as polyols are polymers and copolymers that contain hydroxyl groups in the polymer chain or in side groups, e.g. polyvinyl alcohol and copolymers thereof or polymethacrylic acid hydroxyalkyl esters or copolymers thereof. Further suitable polyols are oligoesters having hydroxyl terminal groups.

Examples of aliphatic and cycloaliphatic polyols include alkylenediols having preferably from 2 to 12 carbon atoms, such as ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols having molecular weights of preferably from 200 to 1500, 1,3-cyclopentanediol, 1,2-, 1,3- or 1,4-cyclohexanediol, 1,4-dihydroxymethylcyclohexane, glycerol, tris(β-hydroxyethyl)amine, trimethylolethane, trimethylolpropane, pentaerythritol, dipentaerythritol and sorbitol.

The polyols may be partially or fully esterified by one or by different unsaturated carboxylic acid(s), it being possible for the free hydroxyl groups in partial esters to be modified, for example etherified, or esterified by other carboxylic acids.

Examples of esters are:

trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol trisitaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetramethacrylate, sorbitol pentaacrylate, sorbitol hexaacrylate, oligoester acrylates and methacrylates, glycerol di- and tri-acrylate, 1,4-cyclohexane diacrylate, bisacrylates and bismethacrylates of polyethylene glycol having a molecular weight of from 200 to 1500, and mixtures thereof.

Also suitable as a component are the amides of identical or different unsaturated carboxylic acids and aromatic, cycloaliphatic and aliphatic polyamines having preferably from 2 to 6, especially from 2 to 4, amino groups. Examples of such polyamines are ethylenediamine, 1,2- or 1,3-propylenediamine, 1,2-, 1,3- or 1,4-butylenediamine, 1,5-pentylenediamine, 1,6-hexylenediamine, octylenediamine, dodecylenediamine, 1,4-diaminocyclohexane, iso-phoronediamine, phenylenediamine, bisphenylenediamine, di-aminoethyl ether, diethylenetriamine, triethylenetetramine and di(β-aminoethoxy)- and di(β-aminopropoxy)-ethane. Further suitable polyamines are polymers and copolymers which may have additional amino groups in the side chain and oligoamides having amino terminal groups. Examples of such unsaturated amides are: methylene bisacrylamide, 1,6-hexamethylene bisacrylamide, diethylenetriamine trismethacrylamide, bis(methacrylamidopropoxy)ethane, β-methacrylamidoethyl methacrylate and N-[(β-hydroxyethoxy)ethyl]-acrylamide.

Suitable unsaturated polyesters and polyamides are derived, for example, from maleic acid and diols or diamines. The maleic acid may have been partially replaced by other dicarboxylic acids. They may be used together with ethylenically unsaturated comonomers, e.g. styrene. The polyesters and polyamides may also be derived from dicarboxylic acids and ethylenically unsaturated diols or diamines, especially from those having longer chains of e.g. from 6 to 20 carbon atoms. Examples of polyurethanes are those composed of saturated diisocyanates and unsaturated diols or unsaturated diisocyanates and saturated diols.

Polybutadiene and polyisoprene and copolymers thereof are known. Suitable comonomers include, for example, olefins, such as ethylene, propene, butene and hexene, (meth)acrylates, acrylonitrile, styrene and vinyl chloride. Polymers having (meth)acrylate groups in the side chain are likewise known. Examples are reaction products of novolak-based epoxy resins with (meth)acrylic acid; homo- or co-polymers of vinyl alcohol or hydroxyalkyl derivatives thereof that have been esterified with (meth)acrylic acid; and homo- and co-polymers of (meth)acrylates that have been esterified with hydroxyalkyl (meth)acrylates.

As mono- or poly-unsaturated olefinic compound there is especially used an acrylate, methacrylate or vinyl ether compound. Polyunsaturated acrylate compounds, such as have already been listed hereinabove, are more especially preferred.

In principle it is advantageous for the solutions, suspensions or emulsions to be applied as quickly as possible, but for many purposes it may also be acceptable to carry out step b) after a time delay. Preferably, however, method step b) is carried out directly after or within 24 hours after method step a).

Application of the solutions, suspensions or emulsions can be carried out in a variety of ways. Application can be effected by electrophoretic deposition, immersion, spraying, coating, brush application, knife application, rolling, roller application, printing, spin-coating and pouring.

The concentration of initiators in the liquids to be applied is from 0.01 to 20%, preferably from 0.1 to 5%. The concentration of ethylenically unsaturated compounds in those liquids is from 0.1 to 30%, preferably from 0.1 to 10%.

The liquids may additionally comprise other substances, for example defoamers, emulsifiers, surfactants, anti-fouling agents, wetting agents and other additives customarily used in the coatings and paints industry.

The thickness of the applied layer in the dry state is likewise matched to the requirements of the later use and ranges from a monomolecular layer up to 2 mm, especially from 2 nm to 1000 μm, more especially from 2 nm to 1000 nm.

In principle it is advantageous for the melts, solutions, suspensions or emulsions to be heated, dried or irradiated as rapidly as possible, since the layer is fixed and stabilised by means of that step, but it may also be acceptable for many purposes for step c) to be carried out after a time delay. Preferably, however, method step c) is carried out directly after or within 24 hours after method step b).

Many possible methods of heating/drying coatings are known and they can all be used in the claimed method. Thus, for example, it is possible to use hot gases, IR radiators, ovens, heated rollers and microwaves. The temperatures used for that purpose are governed by the thermal stability of the materials used and generally range from 0 to 300° C.; preferably, they are from 0 to 200° C.

In the case of particularly temperature-sensitive materials, irradiation with electromagnetic waves may be advantageous. Care must be taken that the initiator used is one which absorbs also in the wavelength ranges in which the UV absorber exhibits no or only little absorption. Irradiation of the coating can be carried out using any source that emits electromagnetic waves of wavelengths that can be absorbed by the photoinitiators employed. Such sources are generally those which emit electromagnetic radiation of wavelengths in the range from 200 nm to 2000 nm. In addition to customary radiators and lamps, it is also possible to use lasers and LEDs (Light Emitting Diodes). The whole area or parts thereof can be irradiated. Partial irradiation is of advantage when only certain regions are to be rendered adherent. Irradiation can also be carried out using electron beams. The whole area and/or parts thereof can be irradiated, for example, by means of irradiation through a mask or using laser beams. By that means it is possible to achieve fixing and stabilisation of the coating in certain regions only. In unexposed regions, the layer could be washed off again and in that manner structuring achieved.

Step c) can be carried out in air or under inert gas. Nitrogen gas comes into consideration as the inert gas, but other inert gases, such as CO₂ and argon, helium etc. or mixtures thereof, can also be used. Suitable equipment and apparatus will be known to the person skilled in the art and are commercially available.

In general, once the method is complete the invention does not require the application of a further coating. In some cases, however, it may be advantageous to provide a further layer, for example a colouring layer, but the photoinitiator-coated substrate, for example, will not be coated with a composition containing at least one ethylenically unsaturated monomer or oligomer and the resulting coating cured by means of UV/VIS radiation.

Also claimed are coatings produced in accordance with one of the methods described above.

Also claimed are products that have been provided with a coating in accordance with one of the preceding claims.

The described method provides a quick, simple and flexible way of producing functional layers and controlling their properties. For example, it is possible to adjust the hydrophilicity/hydrophobicity or the surface tension of the coated substrates. The use of water-soluble or hydrophilic initiators and water-soluble or hydrophilic ethylenically unsaturated compounds enables hydrophilic layers to be obtained and their wetting behaviour controlled. Such layers can be used, for example, as anti-fogging coatings or for improving cell adhesion and growth on the surfaces. By the use of fluorinated unsaturated compounds or appropriate hydrophobic monomers, for example silicone acrylates, it is possible to produce anti-stick and anti-graffiti layers and/or to control the anti-frictional and frictional properties.

By the use of ethylenically unsaturated compounds carrying additional groups that have an acid, neutral or basic reaction (e.g. allylamine, 2-aminoethyl methacrylate, 4-vinylpyridine, acrylic acid, 2-propene-1-sulfonic acid) it is also possible to control the acid/base properties. By the use of suitable compounds, the refractive index of the coating can be adjusted. For example, a high refractive index can be obtained by the use of benzyl acrylate and a low refractive index by the use of 1 H,1 H,7H-dodecafluoroheptyl methacrylate.

The use of biologically active substances can be utilised for the production of layers that cannot be populated or attacked by organisms. For example, anti-fouling layers can be produced using dibutyltin maleate. On the other hand, by suitable selection of the compounds it is also possible to produce surfaces that promote the adhesion and growth of biological systems. N-Acyloxysuccinimide and 2-methacryloxyethyl glucoside, for example, would come into consideration for that purpose.

Flame-retardant properties can be achieved by the use of halogen-containing compounds, for example by the use of tribromoneopentyl methacrylate.

The Examples which follow illustrate the invention.

### EXAMPLE 1

A white-pigmented polypropylene film (300 μm) is corona-treated in air four times using a ceramic electrode (manual corona station type CEE 42-0-1 MD, width 330 mm, SOFTAL) at a distance of about 1-2 mm and at an output of 600 W and a treatment rate of 10 cm/s. An ethanolic solution containing 0.5% initiator of the following structural formula

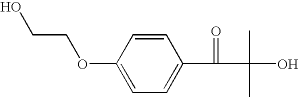

and 0.5% polyethylene glycol (400) diacrylate (Sartomer) is applied to the treated side of the film using a 4 μm knife (Erichsen). The specimens are stored briefly until the alcohol has evaporated and the specimens are dry. The specimens are then irradiated using a UV processor (Fusion Systems) having a microwave-excited mercury lamp and an output of 120 W/cm at a belt speed of 15 m/min. The surface tension is determined by means of test inks and a value of 56 mN/m is obtained, which does not change over a storage period of 6 weeks. Values of <34 mN/m are measured on untreated films.

### EXAMPLE 2

A transparent polyethylene film (LDPE 150 μm) is corona-treated in air four times using a ceramic electrode (manual corona station type CEE 42-0-1 MD, width 330 mm, SOFTAL) at a distance of about 1-2 mm and at an output of 400 W and a treatment rate of 10 cm/s. An ethanolic solution containing 1% initiator of the following structural formula

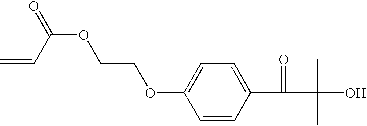

is applied to the treated side of the film using a 4 μm knife (Erichsen). The specimens are stored briefly until the alcohol has evaporated and the specimens are dry. The specimens are then irradiated using a UV processor (Fusion Systems) having a microwave-excited mercury lamp and an output of 120 W/cm at a belt speed of 15 m/min. The surface tension is determined by means of test inks and a value of 48 mN/m is obtained, which does not change over a storage period of 6 weeks. Values of <34 mN/m are measured on untreated films.

### EXAMPLE 3

The procedure is as in Example 1, but during the irradiation a portion of the film is covered with an aluminium sheet. The film is then treated with ultrasound for 1 minute in ethanol. In the non-irradiated region, water droplets exhibit a large contact angle on account of the greater hydrophobicity of the film, whereas in the irradiated region the contact angle is small and the drops deliquesce.

### EXAMPLE 4

A transparent polypropylene film (BOPP 50 μm) is corona-treated in air four times using a ceramic electrode (manual corona station type CEE 42-0-1 MD, width 330 mm, SOFTAL) at a distance of about 1-2 mm and at an output of 600 W and a treatment rate of 10 cm/s. An ethanolic solution containing 1% initiator of the following structural formula

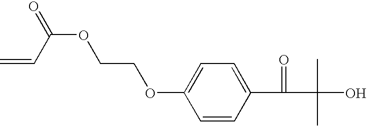

and 1% 2-hydroxyethyl methacrylate (Fluka) is applied to the treated side of the film using a 4 μm knife (Erichsen). The specimens are stored briefly until the alcohol has evaporated and the specimens are dry. The specimens are then irradiated using a UV processor (Fusion Systems) having a microwave-excited mercury lamp and an output of 120 W/cm at a belt speed of 15 m/min. Very thin, clear films are formed. The films are placed, coated side down, on a petri dish containing paper that has been soaked in water. The film and the paper are about 0.5 cm apart. A drop of water is then applied to the untreated side of the film in order to cool the film and to condense evaporating water. In the case of untreated film, droplets form on the side of the film facing the paper after a short time. In the case of the treated film, no droplet formation (fogging) is observed.

### EXAMPLE 5

A transparent polyethylene film (LDPE 200 μm) is corona-treated in air four times using a ceramic electrode (manual corona station type CEE 42-0-1 MD, width 330 mm, SOFTAL) at a distance of about 1-2 mm and at an output of 250 W and a treatment rate of 10 cm/s. An ethanolic solution containing 1% initiator of the following structural formula

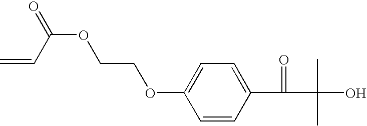

and 1% 2-hydroxyethyl methacrylate (Fluka) is applied to the treated side of the film using a 4 μm knife (Erichsen). The specimens are stored briefly until the alcohol has evaporated and the specimens are dry. They are then irradiated using a UV processor (Fusion Systems) having a microwave-excited mercury lamp and an output of 120 W/cm at a belt speed of 15 m/min. Very thin, clear films are formed. The films are placed, coated side down, on a petri dish containing paper that has been soaked in water. The film and the paper are about 0.5 cm apart. A drop of water is then applied to the untreated side of the film in order to cool the film and to condense evaporating water. In the case of untreated film, droplets form on the side of the film facing the paper after a short time. In the case of the treated film, very little droplet formation (fogging) is observed.

1. A method for forming a functional layer on an inorganic or organic substrate, wherein:
a) a low-temperature plasma, a corona discharge, high-energy radiation and/or a flame treatment is caused to act on the inorganic or organic substrate,
b) 1) at least one activatable initiator or 2) at least one activatable initiator and at least one ethylenically unsaturated compound is/are applied in the form of a melt, solution, suspension or emulsion to the inorganic or organic substrate, there being incorporated in the activatable initiator and/or the ethylenically unsaturated compound at least one function-controlling group which results in the treated substrate's acquiring desired surface properties, and
c) the coated substrate is heated and/or is irradiated with electromagnetic waves, the substrate thereby acquiring the desired surface properties.

2. A method according to claim 1, wherein the function-controlling group is composed as follows:
i) a hydrophilic or hydrophobic group for controlling hydrophilicity/hydrophobicity,
ii) an acid, neutral or basic functional group for controlling acid/base properties,
iii) a functional group having high or low incremental refraction, for controlling the refractive index,
iv) a functional group having an effect on the growth of cells and/or organisms, for controlling biological properties,
v) a functional group having an effect on combustibility, for controlling flame-retardant properties, and/or
vi) a functional group having an effect on electrical conductivity, for controlling anti-static properties.

3. A method according to claim 2, wherein as hydrophilic group there is used a polar group, such as an alcohol, ether, acid, ester, aldehyde, keto, sugar, phenol, urethane, acrylate, vinyl ether, epoxy, amide, acetal, ketal, anhydride, quaternised amino, imide, carbonate or nitro group, a salt of an acid, or a (poly)glycol unit.

4. A method according to claim 2, wherein the hydrophilic group there is chosen from acrylic acid, acrylamide, acetoxystyrene, acrylic anhydride, acrylsuccinimide, allyl glycidyl ether, allylmethoxyphenol, polyethylene glycol (400) diacrylate, diethylene glycol diacrylate, diurethane dimethacrylate, divinyl glycol, ethylene glycol diglycidyl ether, glycidiyl acrylate, glycol methacrylate, 4-hydroxybutyl methacrylate, 2-hydroxyethyl acrylate, 2-hydroxyethyl methacrylate, N-(2-hydroxypropyl)methacrylamide, methacryloxyethyl glucoside, nitrostyrene, sulfoethyl methacrylate, sodium salt of 3-sulfopropyl acrylate, 4-vinylbenzoic acid, vinyl methyl sulfone, vinylphenylacetate or vinylurea.

5. A method according to claim 2, wherein the hydrophobic group is a non-polar group, chosen from a branched or unbranched alkane, alkene, alkyne, partially or fully halogenated alkane or alkene or alkyne, alkylated amine, linear or branched silane or siloxane group or a partially or fully halogenated aromatic or non-aromatic cyclic group.

6. A method according to claim 2, wherein the hydrophobic group is chosen from tert-butyl acrylate, styrene, butyl trimethoxysilane, cyclohexyl acrylate, decanediol dimethacrylate, divinylbenzene, 2-(2-ethoxyethoxy)ethyl acrylate, 1H,1H-heptafluorobutyl acrylate, benzyl acrylate, 1H,1H,7H-dodecafluoroheptyl methacrylate, naphthyl acrylate, pentabromophenyl acrylate, trifluoroethyl acrylate or vinyltriphenylsilane.

7. A method according to claim 2, wherein the functional group controlling acid/base properties is chosen from a carboxylic acid, sulfonic acid, phosphoric acid, sulfuric acid, phenolic acid or amino acid group or an amino, pyridine, pyrimidine, piperidine, pyrrole or imidazole group.

8. A method according to claim 2, wherein the functional group controlling acid/base properties is chosen from allylamine, 2-aminoethyl methacrylate, 4-vinylpyridine, vinylpyrrolidone, vinylimidazole, morpholinoethyl acrylate, acrylic acid, 2-propene-1-sulfonic acid, sorbic acid, cinnamic acid or maleic acid.

9. A method according to claim 2, wherein the group controlling the refractive index is chosen from a benzyl group, a partially or fully halogenated benzyl group or a partially or fully halogenated alkane or alkene or alkyne group.

10. A method according to claim 2, wherein the group controlling the refractive index is chosen from benzyl acrylate, 1H,1H,7H-dodecafluoroheptyl methacrylate, 1H,1H-heptafluorobutyl acrylate or trifluoroethyl acrylate.

11. A method according to claim 2, wherein the group controlling biological properties is chosen from a group having anti-fouling properties, such as copper(II) methacrylate, dibutyltin maleate, tin(II) methacrylate or zinc dimethacrylate.

12. A method according to claim 2, wherein the group controlling biological properties is chosen from a group that promotes the growth of biological systems, wherein the group that promotes the growth of biological systems is chosen from a succinimide, glucoside or sugar group.

13. A method according to claim 12, wherein as a group that promotes the growth of biological systems is chosen from N-acyloxysuccinimide or 2-methacryloxyethyl glucoside.

14. A method according to claim 2, wherein the group controlling flame-retardant properties is chosen from a fully or partially chlorinated or brominated alkane or nitrogen- or phosphorus-containing group.

15. A method according to claim 2, wherein the group controllling flame-retardant properties is chosen from tribromoneopentyl methacrylate, bis(2-methacryloxyethyl)phosphate or monoacryloxyethyl phosphate

16. A method according to claim 2, wherein the group controlling anti-static properties is chosen from a tertiary amino, ethoxylated amino, alkanol amide, glycerol stearate, sorbitan or sulfonate group.

17. A method according to claim 2, wherein the group controlling anti-static properties is chosen from 2-diisopropylaminoethyl methacrylate, 3-dimethylaminoneopentyl acrylate or oleylbis(2-hydroxyethyl)amine, stearyl acrylate, or vinyl stearate.

18. A method according to claim 1, wherein the inorganic or organic substrate is or comprises a synthetic or natural polymer, a metal oxide, a glass, a semi-conductor, quartz or a metal.

19. A method according to claim 18, wherein the organic substrate is or comprises a homopolymer, block polymer, graft polymer and/or copolymer and/or a mixture thereof.

20. A method according to claim 19, wherein the organic substrate is or comprises a polycarbonate, polyester, halogen-containing polymer, polyacrylate, polyolefin, polyamide, polyurethane, polystyrene, polyaramide, polyether or polysiloxane/silicone.

21. A method according to claim 1, wherein the initiator is a compound or combination of compounds from the classes of the peroxides, peroxodicarbonates, persulfates, benzpinacols, dibenzyls, disulfides, azo compounds, redox systems, benzoins, benzil ketals, acetophenones, hydroxyalkylphenones, aminoalkylphenones, acylphosphine oxides, acylphosphine sulfides, acyloxyiminoketones, peroxy compounds, halogenated acetophenones, phenyl glyoxylates, benzophenones, oximes and oxime esters, thioxanthones, ferrocenes, titanocenes, sulfonium salts, iodonium salts, diazonium salts, onium salts, borates, triazines, bisimidazoles, polysilanes and dyes, and also corresponding coinitiators and/or sensitisers.

22. A method according to claim 1, wherein the initiator has at least one ethylenically unsaturated group.

23. A method according to claim 22, wherein the ethylenically unsaturated compound is used in the form of a monomer, oligomer and/or polymer.

24. A method according to claim 23, wherein the ethylenically unsaturated compound is a mono-, di-, tri-, tetra- or poly-functional acrylate, methacrylate or vinyl ether.

25. A method according to claim 1, wherein the plasma is run in a gas and the gas is air, water, inert gas, reactive gas or a mixture of the afore-mentioned gases.

26. A method according to claim 1, wherein the in the melt, solution, suspension or emulsion in method step b) contains the initiator(s) in a concentration of from 0.01 to 20%.

27. A method according to claim 1, wherein the melt, solution, suspension or emulsion used in method step b) contains the unsaturated compound(s) in a concentration of from 0.1 to 30%.

28. A method according to claim 1, wherein the melt, solution, suspension or emulsion used in method step b) additionally comprise other substances chosen from defoamers, emulsifiers, surfactants, anti-fouling agents, wetting agents and other additives customarily used in the coatings industry.

29. A method according to claim 1, wherein the thickness of the applied coating in the dry state ranges from a monomolecular layer up to 2 mm.

30. A method according to claim 1, wherein in method step c) irradiation is carried out using sources which emit electromagnetic waves of wavelengths in the range from 200 nm to 20 000 nm or by means of electron beams, optionally preceded by a drying step.

31. A method according to claim 1, wherein in method step c) irradiation is effected over the whole area or parts thereof.

32. A method according to claim 1, wherein in method step c) partial irradiation is effected and unexposed material is then removed.

33. A substrate having a functional layer, obtainable by a method according to claim 1.

34. A product that has been provided with a coating in accordance with claim 1.

35. (canceled)
